(19) United States
(12) Patent Application Publication
(10) Pub. No.: US 2012/0073850 A1
(43) Pub. Date: Mar. 29, 2012

(54) CONSTRUCTION OF A HANDWELL AND THE LIKE AND METHOD OF USE THEREOF

(75) Inventors: Scott Penson Hickey, Niagara Falls (CA); Siegfried Niedermair, Sharon (CA)

(73) Assignee: TIERCON CORP., Stoney Creek (CA)

(21) Appl. No.: 12/891,551

(22) Filed: Sep. 27, 2010

(51) Int. Cl. H02G 9/00

(52) U.S. Cl. 174/37

(57) ABSTRACT

An handwell or handhole assembly comprises (a) a longitudinally extending tube constructed from an electrical insulating material and comprising an upper end, a lower end and a wire inlet; (b) an inner cover constructed from an electrical insulating material and securable to the upper end of the tube; and, (c) an outer cover constructed from an electrical insulating material and comprising an upper surface, a lower surface and a perimeter and releaseably securable to the inner cover. A method of installing the handwell assembly is also provided

### FIELD

This invention relates to electric handwells, handholes and the like.

### INTRODUCTION

An electric handwell comprises a chamber in the ground in which electrical wiring may be connected together or through which electrical conduits may extend. The handwell has a removable cover so that a worker may access electrical conduits that extend therethrough and/or access electrical conductors therein. Handwells, which are akin to small manholes, are also sometimes referred to as handholes and pull boxes. As used herein, the term “handwell” is used to refer to any such construct.

Referring to FIG. 1, a typical handwell is exemplified. As shown therein, handwell 10 comprises a cylindrical vertically extending wall 12 defining an internal chamber 14. As exemplified, vertically extending wall 12 comprises concrete. The concrete wall is typically formed by providing a form (e.g. a sono tube), which is mounted in the ground and into which concrete may be poured.

Vertically extending wall 12 has an upper end 16 and a lower end 18 and may be of any desired length. Handwell 10 may be positioned in a sidewalk or road, which has an upper surface 22. An access cover 24 is removably mounted above chamber 14. Preferably, the upper surface 32 of access cover 24 is level or essentially level with upper surface 22. Typically, a liner ring 34 made of metal is provided. Access cover 24 may be seated on liner ring 34 and, accordingly, may be flush with upper surface 22. As exemplified, vertically extending wall 12 extends so as to be flush with surface 22 and upper surface 32. Liner ring 34 may be seated in a recess formed in vertically extending wall 12 and may be secured thereto by any means known in the art, such as one or more screws 36. For example, liner ring 34 may be seated in the wet concrete used to from wall 12. When the concrete has cured, one or more screws 36 may be installed. Alternately, for example if the upper end of wall 12 is below grade, a concrete slab (e.g., for a sidewalk) may be poured over wall 12. Re-bar may be used to secure wall 12 and the sidewalk slab together. In such a case, liner ring 34 may be seated in the wet concrete that is used to form the sidewalk slab during initial construction.

One or more openings 28 may be provided in vertically extending wall 12. A plurality of openings 28 may be provided, each of which may have an electrical conduit 26 extending thereto. Electrical conductors (e.g. wires) may extend through conduits 26 and the terminal ends of the wires may be connected together inside chamber 14.

Typically, access covers are constructed from cast metal. More recently, a lightweight plastic access cover has been proposed (see U.S. Pat. No. 7,361,834 Trangsrud et al). As set out in Trangsrud et al, an access cover is provided having a plurality of vertical channels that extend between the top and bottom walls whereby a type of internal corrugated structure is formed. As exemplified therein, the central portion of the lower surface of the access cover is generally flat and the outer annular region of the lower surface is angled upwardly towards the perimeter of the access member. The access cover is placed on a frame. The frame is placed directly on a handhole or an extension provided on the handhole.

### SUMMARY

Over time, the electrical insulating coating on wires in a handwell may degrade. If the wires contact a conductive member of the handwell, e.g. a metal access cover as is traditionally used, a metal liner of the handwell or the concrete wall when the concrete wall is wet, stray electrical current may be conveyed to the surface. Any person or animal in the vicinity of the handwell may accordingly experience an electrical shock. This problem can be acerbated if the ground surrounding the handwell is wet due to rainfall, an in-ground sprinkler system or the like or if the interior of the handwell is flooded.

While the use of a plastic access cover as disclosed in Trangsrud et al can prevent electrical currents being conducted to upper surface 32 of the access cover, the wires in the hand well may still transmit stray electrical currents such as via liner ring 34 (which is typically constructed from metal) or from contacting the vertical wall 12 of the handwell.

In accordance with an aspect of this invention, a handwell or handhole assembly is provided wherein the assembly is constructed from an electrical insulating material to reduce the likelihood of a person or animal standing on or adjacent an access cover of the assembly from receiving an electric shock from the wiring in a handwell.

Accordingly, in one aspect there is provided an handwell or handhole assembly comprising:

(a) a longitudinally extending tube constructed from an electrical insulating material and comprising an upper end, a lower end and a wire inlet;

(b) an inner cover constructed from an electrical insulating material and securable to the upper end of the tube; and,

(c) an outer cover constructed from an electrical insulating material and comprising an upper surface, a lower surface and a perimeter and releaseably securable to the inner cover.

In one embodiment, the tube comprises a double walled tube.

In another embodiment, the wire inlet is at the lower end of the tube.

In another embodiment, the tube comprises a plurality of wire inlets.

In another embodiment, the inner cover is non-removably securable to the upper end of the tube.

In another embodiment, the inner cover has a depending wall that seats inside the tube.

In another embodiment, the inner cover has a perimeter that is proximate the perimeter of the outer cover.

In another embodiment, the tube has a perimeter that is proximate the perimeter of the inner cover.

In another embodiment, the outer cover is constructed from a thermoplastic or thermoset material.

In another embodiment, the inner cover and the outer cover comprises inter fitting members.

In another embodiment, the inter fitting members comprise at least one of a recess or a raised section provided on an upper surface of the inner cover and at least one of a mating recess or a raised section provided on a lower surface of the outer cover comprises.

In another embodiment, the outer cover is constructed from polyurethane or polyamide.

In another embodiment, the upper surface of the outer cover is generally flat and is provided with traction members.

Accordingly, in another aspect there is provided a method of reducing the incidence of electrical shock emanating from a handwell comprising:
(a) positioning a longitudinally extending tube constructed from an electrical insulating material and comprising an upper end, a lower end and a wire inlet;
(b) securing an inner cover constructed from an electrical insulating material to the upper end of the tube;
(c) securing an outer cover constructed from an electrical insulating material to the inner cover.

In one embodiment, the method further comprises adjusting the length of the longitudinally extending tube to fit in a hole provided for the handwell.

In another embodiment the step of adjusting the length of the longitudinally extending tube comprises cutting the longitudinally extending tube to a desired length at the location of the handwell.

In another embodiment, the method further comprises providing at least one wire inlet at a predetermined position along the length of the tube.

In another embodiment, the method further comprises constructing the outer cover is constructed from a thermoplastic or thermoset material.

The method of claim 14 further comprising constructing the outer cover from polyurethane or polyamide.

The method of claim 14 further comprising providing the inner cover and the outer cover with inter fitting members.

### DRAWINGS

Reference is made in the detailed description through the accompanying drawings in which:

FIG. 1 is a cross-sectional view of a prior art handwell;

FIG. 2 is a cross-sectional view of the upper portion an assembly according to one aspect of this invention;

FIG. 3 is a perspective view of a longitudinally extending tube utilized in the assembly of FIG. 2;

FIG. 4 is an exploded view of the assembly of FIG. 2;

FIG. 5a is a partially exploded view of from above of an inner cover and an outer cover showing interlocking recesses and raised portions;

FIG. 5b is a partially exploded view of from below of an inner cover and an outer cover showing interlocking recesses and raised portions;

FIG. 6 is a cross-sectional view showing the inner cover installed on a tube;

FIG. 7 is a cross-sectional view showing the outer cover installed on an inner cover;

FIG. 8 is a perspective view of an alternate tube;

FIG. 9 is a perspective view of a further alternate tube; and,

FIG. 10 is a perspective view from below of an outer or access cover with wires shown in an installed position.

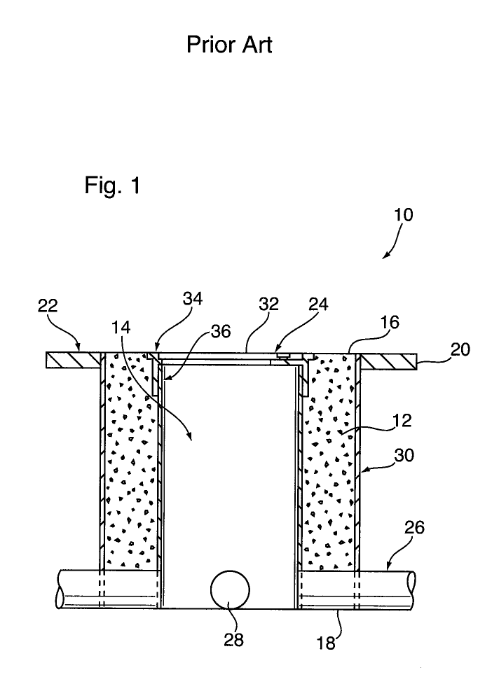

### DESCRIPTION OF VARIOUS EMBODIMENTS

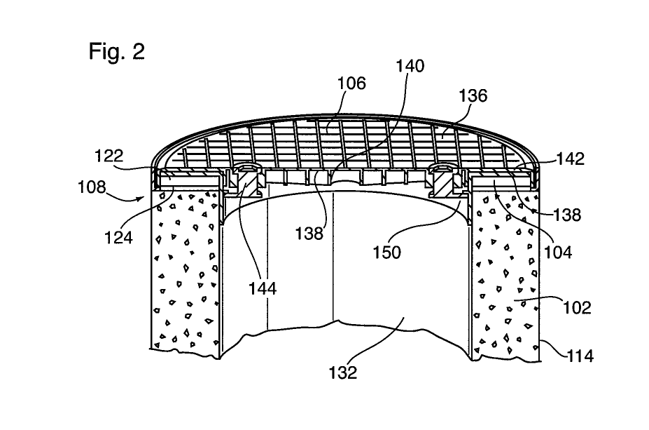

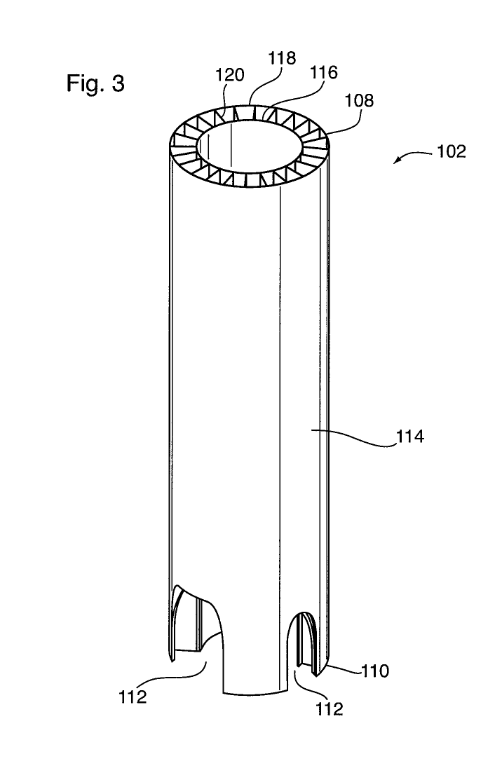

Referring to FIGS. 2-4, handwell or handhold assembly 100 comprises a longitudinally extending tube 102 having an upper end 108 and a lower end 110, an inner cover 104 and an outer cover 106, which is sometimes referred to as an access cover. One or more wire inlets 112 are provided in longitudinally extending tube 100. Wire inlets 112 may be provided at any desired location. Preferably, wire inlets 112 are provided at a lower end 110 of tube 102 and preferably are preferably provided through sidewall 114 thereof. Wire inlets 112 may be sized to receive, or mate with, one or more electrical conduits.

Each of tube 102, inner cover 104 and outer cover 106 are constructed from an electrical insulating material. For example, the electrical insulating material may be a thermoplastic or thermoset material and, preferably, a polyurethane or polyamide. The thermoplastic or themoset materials may include various fillers, such as glass fibres, glass spheres, minerals and other non-conductive fillers. An advantage of this design is that each member of assembly 100 is constructed from an electrical insulating material. Accordingly, if the insulation on the wires or the connectors for the wires in the handwell deteriorate or become frayed, all portions of the assembly will inhibit the transmission of electrical current outside of the handwell.

Preferably, as exemplified, tube 102 comprises a double walled tube. Accordingly, tube 102 may comprise an inner wall 116, an outer wall 118 and a plurality of ribs 120 extending between inner and outer walls 116, 118. As exemplified, ribs 120 may extend radially between inner and outer walls 116, 118. Preferably, ribs 120 extend longitudinally along the length of tube 102 between upper and lower ends 108, 110. It will be appreciated that other structural reinforcing members may be provided to secure inner wall 116 in position with respect to outer wall 118, such as expanding spray foam, a rib structure that may be inserted and fastened, welded or adhesively bonded into place.

An advantage of the utilization of a double walled tube is that tube 102 may have sufficient structural strength so as not to require any reinforcing members inside a hole provided in the ground or the like for the assembly. Accordingly, once assembled, tube 102 will provide sufficient support for any traditional load that may be placed on outer cover 106. For example, if the handwell were positioned in a sidewall or road, tube 102 would provide sufficient strength and structural integrity to permit pedestrians and even cars to traverse across cover 106.

Tube 102 may be constructed by various means known in the art such as extrusion, molding, pulltrusion, roto molding, lost core casting, vacuum molding, blow molding. Most preferably, tube 102 is constructed by extrusion. Accordingly, a continuous length of double walled material may be extruded and cut to the desired length. One or more inlets 112 may then be provided in the extruded material, such as by a saw, to produce tube 102. Alternately, if tube 102 is molded, then inlets 112 may be integrally formed during the molding or other forming operation.

Inner cover 104 has an upper surface 122, a lower surface 124 and, preferably, a depending wall 126. Inner cover 104 is generally annular in shape with a central opening that aligns with chamber 132, which is the open area interior of inner wall 116 of tube 102. Depending wall 126 preferably extends downwardly from the radial inner end of inner cover 104 and is preferably positioned so as to be located adjacent and, optionally, touching the inner surface of inner wall 116 when inner cover 104 is placed on tube 102.

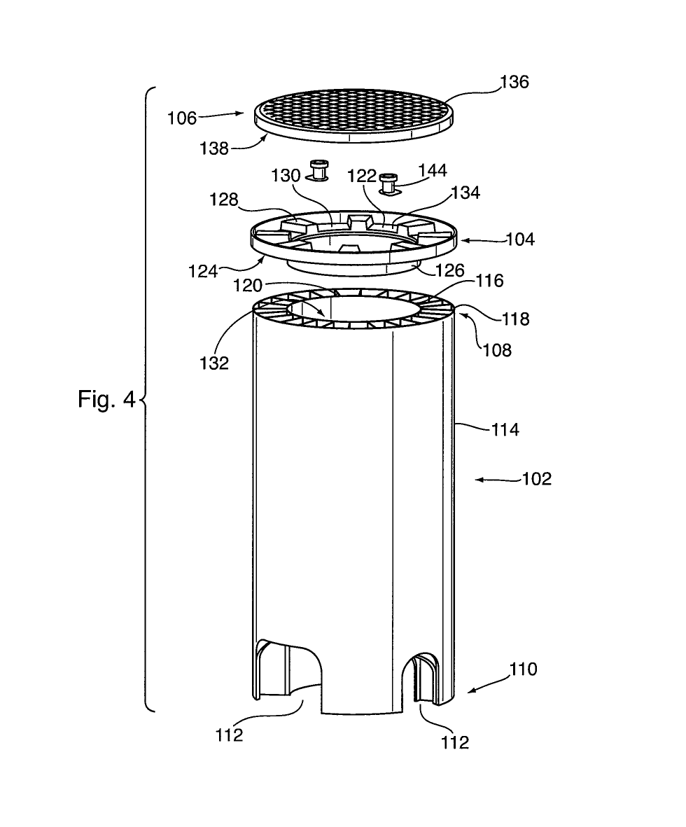

Inner cover 104 may be mounted and, preferably removably mounted, to tube 102 by various means such as an adhesive, a plurality of securing members such as screws, bolts, lugs or the like, integrally molded snap mechanisms, which are inserted downwardly through openings 134 in upper surface 122 into mating members provided in tube 102 and/or by means of securing members such as screws, bolts, lugs or the like which are inserted transversely through depending wall 126 into tube 102. As illustrated in FIG. 4, upper surface 122 is optionally provided with at least one and, preferably, a plurality of raised portions 128. Recesses 130 are provided between adjacent raised portions 128.

Outer cover 106 has an upper surface 136 and a lower surface 138 and an optional depending wall 150. Upper surface 136 is preferably flat and may have a grid pattern or other textured surface so as to provide traction for pedestrians or vehicles, which pass over the cover.

Cover 106 may have a plurality of vertical ribs 140 provided on the lower surface thereof so as to provide structural strength to cover 106 such that cover 106 may support the weight of a person or car that is positioned thereon. It will be appreciated that cover 106 may be of any design that will provide the requisite structural strength.

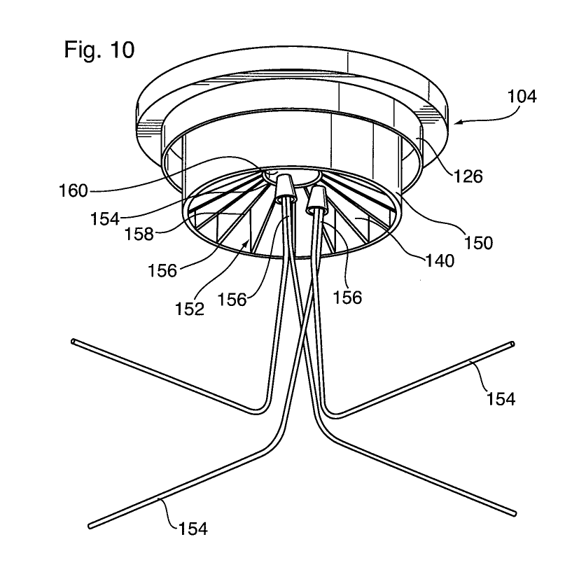

Lower surface 138 of outer cover 106 may be configured to inhibit radial outward migration of wires 154 positioned in handwell 10. In a typical installation, the lower portion of a handwell is filled with dirt, gravel or the like. While conduits 26 may be provided at the lower end of handwell 10, the ends of wires 154 are preferably positioned towards the upper end of handwell 10 so as to facilitate a worker connecting the terminal ends 156 of wires 154 together and being able to service the wires as needed. As exemplified in FIG. 10, during installation of outer cover 106, the connected terminal ends 156 of wires 154 are preferably positioned adjacent the radial inner centre of handwell 10 and within raised central portion 152, e.g., dome shaped portion, of outer cover 106.

By providing raised central area 152 and depending wall 150, terminal ends 156 of wires 154 would have to travel downwardly as well as outwardly prior to contacting vertical wall 12 of handwell 10. It will be appreciated that raised central portion 152 may be of various configurations. For example, it may comprise generally vertical sidewalls, angled sidewalls or, preferably, curved sidewalls. In any such configuration, downward movement of the terminal ends of wires 154 would be required for outward migration of the wires.

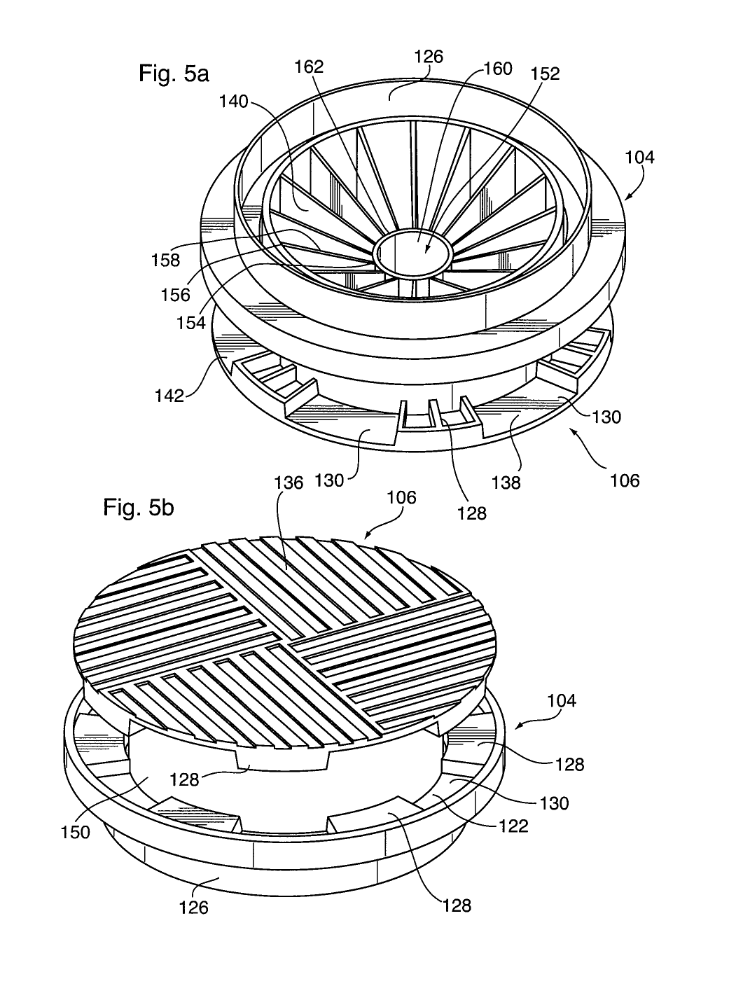

Referring to FIGS. 5a and 10, a preferred raised central portion 152 is exemplified. As exemplified therein, raised central portion 152 is dome shaped. The dome shape is defined by a plurality of ribs 140 that preferably extend downwardly from lower surface 138 of outer cover 106. Ribs 140 have a radial inner end 154, a radial outer end 156 and a lower surface 158, which is curved. Ribs 140 may extend all the way toward the radial inner centre of outer cover 106. Alternately, as exemplified, they may terminate outwardly therefrom at a central hub 160. As exemplified, central hub 160 is defined by a circular depending wall 162 and is hollow. In an alternate embodiment, it will be appreciated that central hub 160 may be of any other configuration and may be solid or have a closed lower surface. In a further alternate embodiment, it will be appreciated that the space between adjacent lower surfaces 158 of ribs 140 may be solid so as to define a continuous dome surface. For example, a cover member (not shown) may be placed over the lower surface 158 of ribs 140.

As exemplified, radial outer ends 156 of ribs 140 terminate at the lower end of depending wall 150. In alternate embodiments, it will be appreciated that radial outer end 156 of ribs 140 may terminate at a position below depending wall 150 or, alternately upwardly form the lower surface of depending wall 150. Further, in an alternate embodiment, the upper end of ribs 140 may terminate at a distance spaced from lower surface 138 of outer cover 106. It will be appreciated that in addition to inhibiting the radial outward migration of wires positioned in the handwell, ribs 140 may also be designed to provide structural strength to outer cover 106.

In alternate embodiments, as exemplified by FIG. 2, lower surface 138 of outer cover 106 may be flat (i.e., extend horizontally once installed).

Lower surface 138 of outer cover 106 is configured so as to seat on inner cover 104. Accordingly, outer cover 106 may be provided with a flange 142 which comprises the portion of outer cover 106 which extends radially outwardly from a position which is aligned with and above depending wall 126 when outer cover 106 is seated on inner cover 104. Accordingly, if inner cover 104 is provided with recesses 130 and raised portions 128, then flange 106 may be provided with mating recesses 130 and raised portions 128 on lower surface 138 that inter fit with recesses 130 and raised portions 128 of inner cover 104 (see for example FIGS. 5a and 5b).

These recesses and raised portions provide interfitting members, which inhibit the rotational motion of cover 106 with respect to cover 104. It will be appreciated that various other structures may be utilizes for the interfitting members such as pins and holes, guide ways and by the shape itself.

Outer cover 106 is secured to inner cover 104, and preferably removably secured thereto, by any means known in the art. Preferably, as exemplified, a plurality of screws 144 extends through openings provided in cover 106 into receiving openings in inner covers 104. In addition to screws, other securing means, which may be utilized, include bolts, lugs, and a snap fit connector.

As exemplified in FIG. 2, the outer diameter or perimeter of each of tube 102, inner cover 104 and outer cover 106 is approximately the same. Accordingly, inner cover 104 will overly all, or essentially all, of the distance between inner and outer walls 116, 118 of tube 102. Similarly, outer cover 106 overlies chamber 132 as well as inner cover 104.

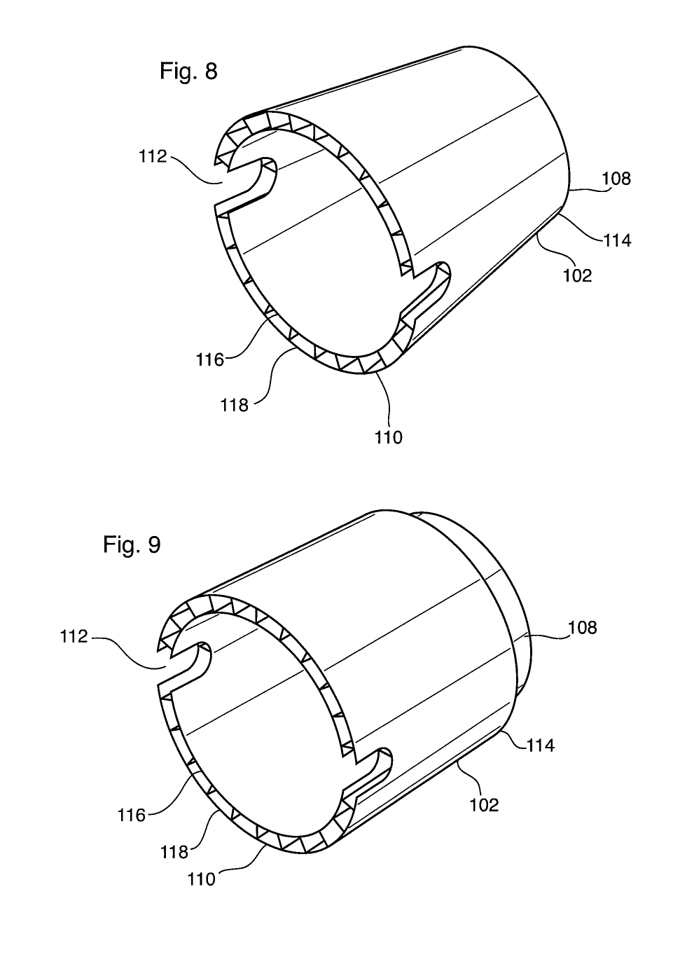

It will be appreciated that sidewall 114 of tube 102 need not extend exactly vertically when installed in the ground. Sidewall 114 may be at an angle to the vertical. For example, as exemplified in FIG. 8, tube 102 is conical in shape and, preferably, flares outwardly from upper end 108 to lower end 110. This permits tube 102 to be wider at the lower end and provide more room for wiring while allowing tube 102 to have a small upper footprint (e.g., 11-12 inches in diameter). Alternately, as shown in FIG. 9, sidewall 114 may be stepped so as to provide a narrower upper end 108 and a wider lower end 110.

Various methods may be utilized to install assembly 100. In accordance with one method, a hole is provided in the ground. The hole may be provided in a lawn, sidewalk or a road. In many methods, the handwell is positioned once the final grade of the surrounding ground has been determined. For example, assembly 100 may be utilized to replace an existing handwell. In such a case, the existing access cover for the handwell may be removed and the existing walls of the handwell may be removed. Tube 102 may then be inserted. Alternately, tube 102 may be positioned interior of the existing walls of a handwell. In either case, the position of the upper end of tube 102 may be determined based on the surface surrounding the handwell. For example, if the handwell is positioned in a sidewalk, then the position for the upper end of tube 102 may be set relative to the upper surface of the sidewalk.

If the assembly is a new installation and not replacing an existing handwell, then the position for the upper end of tube 102 may be determined based on the current or designed position of the surrounding surface. For example, if the handwell is positioned in a road, then the position for the upper end of tube 102 may be set relative to the position of the upper surface of the road when the road is completed.

Once a hole is provided for tube 102, the length of tube 102 is determined. For example, the workers installing the handwell may measure the distance from the bottom of the opening in the ground to the upper surface of the ground (e.g. the top or projected top of a sidewalk or a road surface). Tube 102 may then be cut to the desired length if needed. Alternately, tubing may be ordered of that length. Due to the double walled construction, tube 102 may be simply cut by means of a saw at the site. Tube 102 may then be inserted into the ground and the hole back filled if needed. If electrical conduits are already provided in the ground, openings 112 may be aligned so as to permit conduits 26 to extend therethrough or thereunder. Alternately, the conduits may be extended to tube 102 once tube 102 is positioned in the ground. In another embodiment, inlets 112 may be cut at site once the position of the conduits 26 is known.

The terminal ends of the wires may then be connected if required.

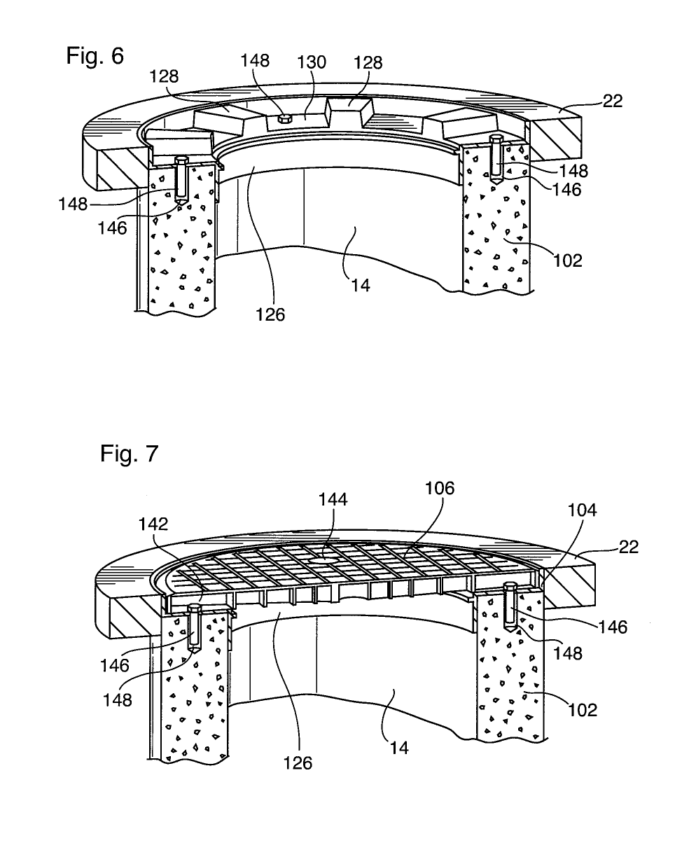

Inner cover 104 may then be installed. Inner cover 104 may be secured to handwell 10 (tube 102) by any securing means, such as screws, lag bolts, epoxy bonded fasteners and adhesive bonding. As exemplified in FIG. 6, inner cover 104 is secured to tube 102 by a plurality of screws 148 that are received in screw holes 146. Alternately, inner cover may be secured in place by an adhesive, a snap fit connector and the like. If a plurality of screws 148 are utilized, a plurality of screw holes 146 may be provided in upper end 104 of tube 102. Inner cover 103 may be seated on upper end 108 and screws 148 then installed.

Outer cover 106 may be removably secured to inner cover 104 and/or tube 102 by any means, such as one or more screws 144, integrally molded plastic bolts, integrally molded snap fits and a quarter turn bayonet style lock. Preferably, one or more screws 144 are utilized that are received in inner cover 104.

If interfitting members are provided on inner and outer covers 104, 106, then outer cover 106 is positioned so as to align the interfitting members as well as, or alternately, to align the openings in outer cover 106 with suitable openings for screws 144 in inner cover 104.

Various apparatus or methods are described above to provide an example of each claimed invention. No example described above limits any claimed invention and any claimed invention may cover processes or apparatuses that are not described above. The claimed inventions are not limited to apparatuses of processes having all the features of any one apparatus or process described above or to features common to multiple or any of the apparatuses described above.

1. An handwell or handhole assembly comprising:
(a) a longitudinally extending tube constructed from an electrical insulating material and comprising an upper end, a lower end and a wire inlet;
(b) an inner cover constructed from an electrical insulating material and securable to the upper end of the tube; and,
(c) an outer cover constructed from an electrical insulating material and comprising an upper surface, a lower surface and a perimeter and releaseably securable to the inner cover.

2. The handwell assembly of claim 1 wherein the tube comprises a double walled tube.

3. The handwell assembly of claim 1 wherein the wire inlet is at the lower end of the tube.

4. The handwell assembly of claim 1 wherein the tube comprises a plurality of wire inlets.

5. The handwell assembly of claim 1 wherein the inner cover is non-removably securable to the upper end of the tube.

6. The handwell assembly of claim 1 wherein the inner cover has a depending wall that seats inside the tube.

7. The handwell assembly of claim 1 wherein the inner cover has a perimeter that is proximate the perimeter of the outer cover.

8. The handwell assembly of claim 7 wherein the tube has a perimeter that is proximate the perimeter of the inner cover.

9. The handwell assembly of claim 1 wherein the outer cover is constructed from a thermoplastic or thermoset material.

10. The handwell assembly of claim 1 wherein the inner cover and the outer cover comprises inter fitting members.

11. The handwell assembly of claim 10 wherein the inter fitting members comprise at least one of a recess or a raised section provided on an upper surface of the inner cover and at least one of a mating recess or a raised section provided on a lower surface of the outer cover comprises.

12. The handwell assembly of claim 1 wherein the outer cover is constructed from polyurethane or polyamide.

13. The handwell assembly of claim 1 wherein the upper surface of the outer cover is generally flat and is provided with traction members.

14. A method of reducing the incidence of electrical shock emanating from a handwell comprising:
(a) positioning a longitudinally extending tube constructed from an electrical insulating material and comprising an upper end, a lower end and a wire inlet;
(b) securing an inner cover constructed from an electrical insulating material to the upper end of the tube;
(c) securing an outer cover constructed from an electrical insulating material to the inner cover.

15. The method of claim 14 further comprising adjusting the length of the longitudinally extending tube to fit in a hole provided for the handwell.

16. The method of claim 15 wherein the step of adjusting the length of the longitudinally extending tube comprises cutting the longitudinally extending tube to a desired length at the location of the handwell.

17. The method of claim 14 further comprising providing at least one wire inlet at a predetermined position along the length of the tube.

18. The method of claim 14 further comprising constructing the outer cover is constructed from a thermoplastic or thermoset material.

19. The method of claim 14 further comprising constructing the outer cover from polyurethane or polyamide.

20. The method of claim 14 further comprising providing the inner cover and the outer cover with inter fitting members.
